(19) United States
(12) Patent Application Publication
(10) Pub. No.: US 2008/0081109 A1
(43) Pub. Date: Apr. 3, 2008

(54) POROUS ABRADABLE COATING AND METHOD FOR APPLYING THE SAME

(75) Inventors: Curtis Alan Johnson, Niskayuna, NY (US); Yuk-Chiu Lau, Ballston Lake, NY (US); Joshua Lee Margolies, Niskayuna, NY (US); Herbert Chidsey Roberts, Simpsonville, SC (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 11/537,238

(22) Filed: Sep. 29, 2006

(51) Int. Cl. B05D 1/12; B05D 1/36; B05D 1/32

(52) U.S. Cl. 427/180; 427/202; 427/282

(57) ABSTRACT

Disclosed is a porous abradable coating including at least one abradable layer applicable to a substrate, said at least one abradable layer comprising coarsely cut powder pieces.

### FIELD OF THE INVENTION

The disclosure relates generally to abradable coatings, and more specifically to porous abradable coatings applied to a substrate.

### BACKGROUND OF THE INVENTION

In a gas turbine engine, in order to achieve maximum engine efficiency (and corresponding maximum electrical power generation), it is important that the buckets rotate within the turbine casing or “shroud” with minimal interference and with the highest possible efficiency relative to the amount of energy available from the expanding working fluid. Typically, highest operation efficiencies can be achieved by maintaining a minimum threshold clearance between the shroud and tips of the bucket. Maintaining a minimum clearance prevents unwanted “leakage” of a hot gas over tip of the buckets, increased clearances lead to leakage problems and cause significant decreases in overall efficiency of the turbine. However, it should be appreciated that if bucket tips rub against a particular location of the shroud such that the bucket tip is eroded, the erosion of the bucket tip increases clearances between bucket tip and shroud in other locations, again resulting in unwanted leakage.

The need to maintain adequate clearance without significant loss of efficiency is made more difficult by the fact that as the turbine rotates, centrifugal forces acting on the turbine components can cause the buckets to expand in an outward direction toward the shroud, particularly when influenced by the high operating temperatures. Thus, it is important to establish the lowest effective running clearances between the shroud and bucket tips at the maximum anticipated operating temperatures.

Abradable type coatings have been applied to the turbine shroud to help establish a minimum, i.e., optimum, running clearance between the shroud and bucket tips under steady-state temperature conditions. In particular, coatings have been applied to the surface of the shroud facing the buckets using a material that can be readily abraded by the tips of the buckets as they turn inside the shroud at high speed with little or no damage to the bucket tips. Initially, a clearance exists between the bucket tips and the coating when the gas turbine is stopped and the components are at ambient temperature. Later, during normal operation the clearance decreases due to the centrifugal forces and temperature changes in rotating and stationary components inevitably resulting in at least some radial extension of the bucket tips, causing them to contact the coating on the shroud and wear away a part of the coating to establish the minimum running clearance. With abradable coatings clearances can be reduced with the assurance that if contact occurs, the sacrificial part is the abradable coating instead of the bucket tip.

Though abradable coatings are effective clearance minimizers, a coating that, as a whole, could better withstand local rubs (i.e. withstand a local rub on the coating without wholesale or large area delamination of the coating) would be desirable. This can be achieved via increased coating porosity. Currently, coating porosity is achieved by including a polymeric component in the coating, the polymeric component being burned out after coating application, leaving behind a porosity. A more efficient and effective means of creating porosity in a abradable coating is desirable.

### BRIEF DESCRIPTION OF THE INVENTION

Disclosed is a porous abradable coating including at least one abradable layer applicable to a substrate, said at least one abradable layer comprising coarsely cut powder pieces.

Also disclosed is a method for applying a porous abradable coating, the method including selecting a coarsely cut abradable powder comprising coarsely cut powder pieces, applying at least one abradable layer comprising the coarsely cut abradable powder to a substrate, and creating a porosity in the at least one layer via the coarsely cut abradable powder.

Further disclosed is a method for applying a porous abradable coating, the method including selecting a coarsely cut abradable powder comprising coarsely cut powder pieces, applying an adhesion abradable layer comprising the coarsely cut powder to a substrate, applying a patterned abradable layer including the coarsely cut abradable powder to the adhesion abradable layer, adhering the patterned abradable layer to the adhesion abradable layer, the adhering being promoted via a roughness of the coarsely cut abradable powder, and creating a porosity in the adhesion layer and the patterned layer via the coarsely cut abradable powder pieces.

### BRIEF DESCRIPTION OF THE DRAWINGS

Referring now to the drawings wherein like elements are numbered alike in the several FIGURES:

FIG. 1 is a schematic cross-section of a porous abradable coating;

FIG. 2 is a schematic cross-section of section 2 of FIG. 1;

FIG. 3 is a schematic cross-section of an adhesive layer of the porous abradable coating being applied; and

FIG. 4 is a schematic cross-section of a patterned layer of the porous abradable coating being applied.

### DETAILED DESCRIPTION OF THE INVENTION

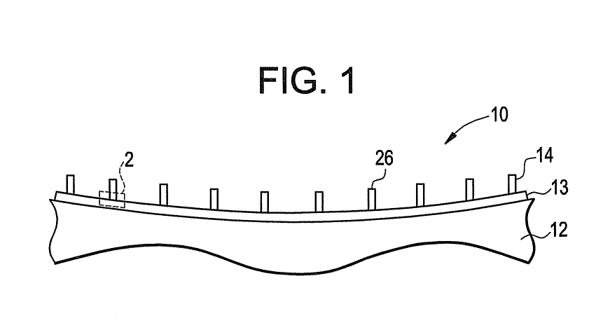

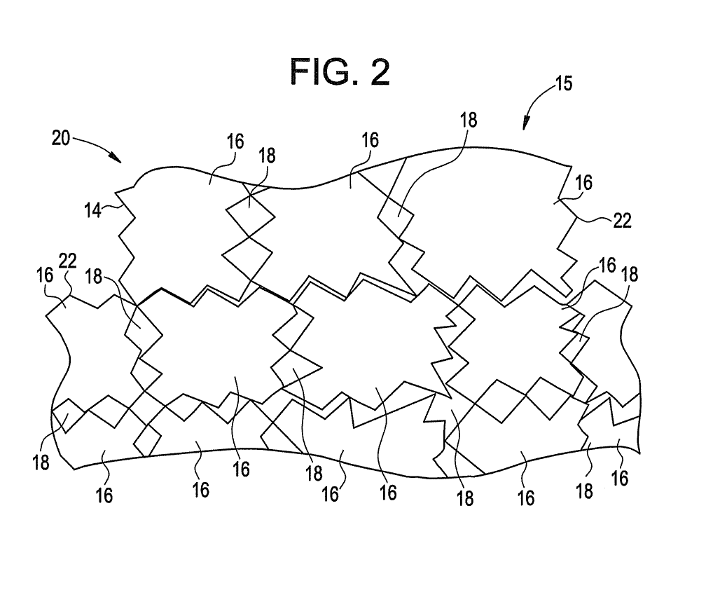

Referring to FIG. 1, a porous abradable coating 10 is illustrated. The coating 10 is applied to a substrate 12, such as an environmental barrier coated (EBC) turbine shroud, in at least one layer. In an exemplary embodiment, the coating 10 is applied in an adhesion abradable layer 13 and a patterned abradable layer 14. A method for applying the coating 10 will be discussed hereinbelow, beginning with selection of the powder 15 (as shown in FIG. 2) comprising the coating 10.

Referring to FIG. 2, the powder 15 is selected to include relatively large, coarse cut pieces 16. The selection process involves a sifting of the abradable powder 15 through a screen that includes square openings approximately 90 microns across. The powder 15 that passes through these openings is then sifted through a screen that includes square openings approximately 44 microns across. The powder 15 that passes through these openings is then discarded, and the powder 15 that cannot pass is selected. Thus, pieces 16 with an approximate diameter between 44 and 90 microns are used. By comparison, other more conventional powders 15 use a finer powder that includes pieces as small as 8 (ceramic) and 16 (metal) microns.

The largeness and coarseness of the pieces 16 allows the powder 15 applied in the layers 14 and 13 to include relatively large open voids 18. In an exemplary embodiment, these voids 18 allow for a relatively large coating porosity 20 of at least 8 percent volume (with an exemplary range of 8-12%), even after a heat treatment that will be discussed later in the disclosure. In addition to creating the desired porosity 20, the coarseness of the pieces 16 produce a degree of roughness 22 in the adhesion layer 13 that promotes adhesion to the patterned layer 14. It should be appreciated that in an exemplary embodiment the powder 15 includes a ceramic composition, which may specifically comprise yttria stabilized zirconia, barium strontium aluminosilicate, and a composition including 0.75 mole BaO, 0.25 mole SrO, 1 mole Al203, and 2 moles SiO2.

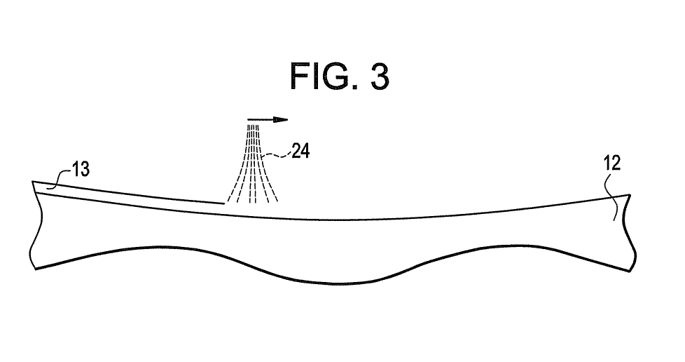

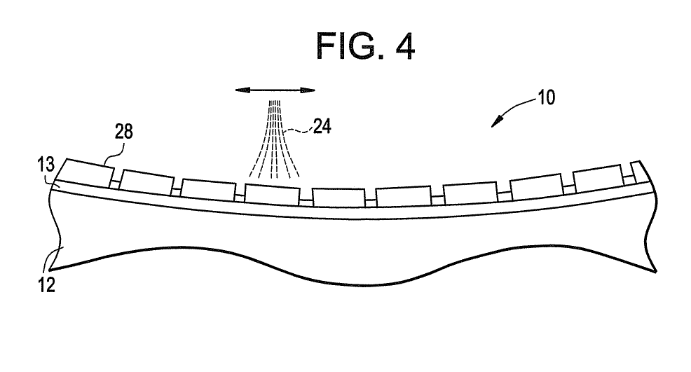

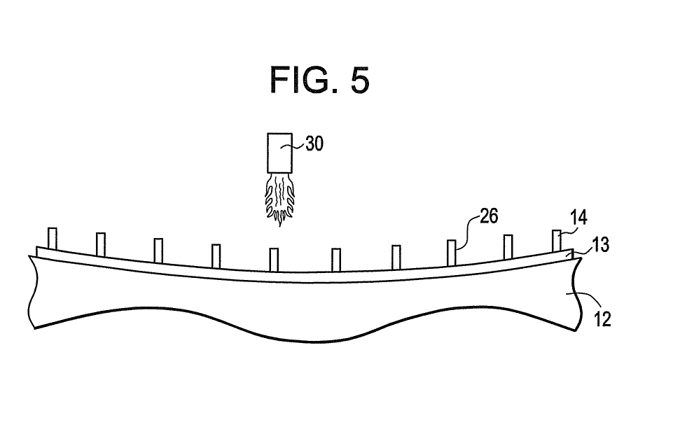

Once the powder 15 is selected, the coating 10 may be applied. Referring to FIG. 3, in an exemplary embodiment the adhesion layer 13 (partially applied in the Figure) is applied or “flash-coated” to the substrate 12 via a thermal spray process, such as air plasma spray 24 or physical vapor deposition (PVD). In an exemplary embodiment, parameter of the air plasma spray is calibrated and optimized for coarse particles that include sizes selected to collectively produce the desired level of porosity. Referring to FIG. 4, the patterned layer 14 is applied to the adhesion layer 13, with a pattern of ridges 26 being formed in the patterned layer 14 (partially applied in the Figure) by, in an exemplary embodiment, successive passes of plasma sprayed powder 15 over a pattern mask 28, with parameter of the air plasma spray again being optimized for coarse particles that include sizes selected to collectively produce the desired level of porosity. As mentioned above, adherence of patterned layer 14 is promoted and strengthened via the roughness 22 of the adhesion layer 13.

To further mechanically and chemically strengthen the adhesive bond between the applied adhesion layer 13 and patterned layer 14, and the pieces 16 within each layer, the layers 13 and 14 are heat-treated. In an exemplary embodiment, this heat treatment is accomplished via an air furnace, though a plasma torch may also be used. The heat is applied at a temperature sufficient enough to partially melt the pieces 16, so as to mechanically and chemically bond each piece 16 to an adjacent piece 16 (and in so doing, strengthen the bond between the layers 13 and 14), aiding in erosion resistance during turbine operation. The temperature is not so great however (between 1250 and 1300 degrees C.), as to completely melt the pieces 16 and decrease porosity by causing the voids 18 to fill with the melting pieces 16. Thus, the combination of moderate heat treatment and particle sizing maintain an incomplete melting, which further maintains the voids 18 between the only semi-molten pieces 16. As nothing has to be completely burned out of the coating 10 to create the desired porosity 20, the integrity of the pieces 16 is substantially preserved, and thus, the desired porosity 20 is efficiently and effectively created.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

1. A porous abradable coating comprising:
at least one abradable layer applicable to a substrate, said at least one abradable layer comprising coarsely cut powder pieces.

2. An abradable coating according to claim 1, wherein said at least one later includes a ceramic composition.

3. An abradable coating according to claim 2, wherein said ceramic composition is at least one of yttria stabilized zirconia, barium strontium aluminosilicate, and a composition including 0.75 mole BaO, 0.25 mole SrO, 1 mole Al203, and 2 moles SiO2.

4. An abradable coating according to claim 1, wherein at least one layer is an adhesion abradable layer applicable to said substrate, and a patterned abradable layer adherable to said adhesion abradable layer, said patterned abradable layer defining at least one ridge.

5. An abradable coating according to claim 1, wherein said at least one abradable layer includes a porosity of at least 8 percent volume.

6. A method for applying a porous abradable coating, the method comprising:
selecting a coarsely cut abradable powder comprising coarsely cut powder pieces;
applying at least one abradable layer comprising said coarsely cut abradable powder to a substrate; and
creating a porosity in said at least one layer via said coarsely cut abradable powder.

7. A method for applying a porous abradable coating, the method comprising:
selecting a coarsely cut abradable powder comprising coarsely cut powder pieces;
applying an adhesion abradable layer comprising said coarsely cut powder to a substrate;
applying a patterned abradable layer including said coarsely cut abradable powder to said adhesion abradable layer;
adhering said patterned abradable layer to said adhesion abradable layer, said adhering being promoted via a roughness of said coarsely cut abradable powder; and
creating a porosity in said adhesion layer and said patterned layer via said coarsely cut abradable powder pieces.

8. A method according to claim 7, further including creating an abradable pattern of ridges in said patterned abradable layer via a patterned mask.

9. A method according to claim 7, wherein said applying said adhesion layer includes applying using a plasma air spray.

10. A method according to claim 8, wherein said applying said patterned layer includes applying using successive passes of a plasma air spray over said patterned mask.

11. A method according to claim 7, further including heat treating said adhesion layer and said patterned layer to allow said adhesion layer and said patterned layer to resist erosion via strengthened adherence, a temperature of said heat treating being selected to retain said desired porosity by incompletely melting said coarsely cut abradable powder pieces.

12. A method according to claim 7, wherein said selecting includes selecting said coarsely cut powder to include a coarseness that allows said desired porosity to be at least 8 percent volume.
